(19) United States
(12) Patent Application Publication
(10) Pub. No.: US 2006/0050907 A1
(43) Pub. Date: Mar. 9, 2006

(54) Loudspeaker with variable radiation pattern

(76) Inventor: Igor Levitsky, Richmond Hill (CA)

Correspondence Address: W. Edward Johansen, 11661 San Vicente Boulevard, Los Angeles, CA, 90049, US

(21) Appl. No.: 10/934,662

(22) Filed: Sep. 3, 2004

(51) Int. Cl. H04R 5/02; H04R 1/02; H04R 9/06

(52) U.S. Cl. 381/304; 381/336; 381/182

(57) ABSTRACT

The invention is a loudspeaker for use in home theater or multi-channel sound systems that includes an enclosure, a wideband transducer, a sound absorbing pad and an aiming knob. The wideband transducer is rotatably mounted in the enclosure so that the wideband transducer can be rotated around its vertical axis and an aiming knob mechanically coupled to the wideband transducer. The wideband transducer has a front side and a rear side open so that said wideband transducer operates as a dipole transducer. The aiming knob controls the rotation angle of the dipole transducer. The loudspeaker uses the dipole transducer to create either a diffuse field or direct radiating surround sound.

This is a continuation-in part of a provisional application, entitled Loudspeaker with Variable Radiation Pattern, filed by Igor Levitsky on Sep. 3, 2003 under Serial No. ______.

### BACKGROUND OF THE INVENTION

Multiple channel sound reproduction systems which include a surround-sound channel (often referred to in the past as an “ambience” or “special-effects” channel) in addition to left and right (and optimally, center) sound channels are now relatively common in motion picture theaters and are becoming more and more common in the homes of consumers. A driving force behind the proliferation of such systems in consumers' homes is the widespread availability of surround-sound home video software, mainly surround-sound motion pictures (movies) made for theatrical release and subsequently transferred to home video media, such as videocassettes, videodiscs and either broadcast or cable television. When a motion picture is transferred from film to home video media, the soundtrack of the motion picture film is transferred essentially unaltered: the soundtrack on the home video medium is essentially an exact duplicate of the soundtrack on the film. Where reference is made below to playing a motion picture soundtrack in the home, it is to be understood that what is actually played in the home is some form of home video medium onto which the motion picture soundtrack has been transferred in an essentially unaltered form.

Although home video media have two-channel stereo-phonic soundtracks, those two channels carry, by means of amplitude and phase matrix encoding, four channels of sound information—left, center, right, and surround, usually identical to the two-channel stereophonic motion-picture soundtracks from which the home video soundtracks are derived. As is also done in the motion picture theater, the left, center, right, and surround channels are decoded and recovered by consumers with a matrix decoder, usually referred to as a “surround-sound” decoder. In the home environment, the decoder is usually incorporated in or is an accessory to a videocassette player, videodisc player, or television set/video monitor.

Motion picture theaters equipped for surround sound typically have at least three sets of loudspeakers, located appropriately for reproduction of the left, center, and right channels, at the front of the theater auditorium, behind the screen. The surround channel is usually applied to a multiplicity of speakers located other than at the front of the theater auditorium. It is the recommended and common practice in the industry to align the sound system of large auditoriums, particularly a motion picture theater's loudspeaker-room response, to a standardized frequency response curve or “house curve.” The current standardized house curve for movie theaters is a recommendation of the International Standards Organization designated as curve X of ISO 2969-1977(E), commonly called the X-curve.

U.S. Pat. No. 5,222,059 teaches a surround sound system that includes a motion picture soundtrack timbre correction, a surround sound channel timbre correction, defined loudspeaker directionality and reduced comb-filter effects. Spectral imbalance alteration in timbre) when playing home video versions of motion pictures having soundtrack equalized for playback in a room whose room-loudspeaker system is aligned to the standard motion picture theater X-curve is overcome by timbre correction which compensates for the X-curve equalization. Surround-sound home playback of motion pictures is enhanced by employing main channel loudspeakers that produce generally direct sound fields and surround channel loudspeakers that produce generally diffuse sound fields. In addition, the reproduced surround-sound channel is further enhanced by decreasing the inter-aural cross-correlation of the surround-sound channel sound field and by reducing comb filtering effects in the surround-sound channel at listening positions within the room, preferably by introducing slight pitch shifting in the signals applied to multiple surround loudspeakers. Preferably, further equalization is applied to the reproduced surround channel to compensate for the differences in listener perceived timbre between the surround-sound channel and the main channels. This aspect is not concerned per se with specific loudspeakers nor with their acoustic coupling to small rooms, but rather it is concerned, in part, with generating direct sound fields for the main (left, right, and, optionally, center) channels and a diffuse sound field for the surround channel in a small (home-sized) room surround-sound system using whatever combinations of available loudspeakers and techniques as may be required to generate such sound fields. This aspect of the invention recognizes that excellent stereophonic imaging and detail combined with sonic envelopment of the listeners can be achieved not only in large (theater-sized) auditoriums but also in the small (home-sized) room by generating generally direct sound fields for the main channels and a generally diffuse sound field for the surround channel. In this way, the home listening experience can more closely re-create the quality theater sound experience. The loudspeaker or loudspeakers are preferably directional loudspeakers that generate, when in their operating positions in the room, left, center (if used), and right channel sound fields in which the free (direct) sound field component is predominant over the diffuse sound field component of each sound field at listening positions within the room. The loudspeaker or loudspeakers is (or are) preferably non-directional so as to generate, when in its or their operating positions in the room, a surround channel sound field in which the diffuse sound field component is predominant over the free (direct) sound field component at listening positions within the room. A non-directional sound field for reproducing the surround channel can be achieved in various ways. Preferably, one or more dipole type loudspeakers each having a generally figure-eight radiation pattern is oriented with one of their respective nulls generally toward the listeners. Other types of loudspeakers having a null in their radiation patterns can also be used. Another possibility is to use a multiplicity of speakers having low directivity arranged around the listeners so as to create an overall sound field that is diffuse. Thus, depending on their placement in the room and their orientation with respect to the listening positions, even loudspeakers having some directivity are capable of producing a predominantly diffuse sound field.

U.S. Pat. No. 5,212,732 teaches an effects loudspeaker system that is of the dipole type, particularly for use in surround sound, reverberation and similar applications. The effect loudspeaker system includes a pair of woofers having dual voice coil drivers mounted on oppositely facing baffles (e.g., front and rear facing). Each baffle includes a high frequency speaker mounted thereon. On a first baffle (e.g., front), both voice coils of the dual voice coil driver and the voice coil of the high frequency speaker are driven in-phase, and on the other baffle (e.g., rear), the second voice coil of the dual voice coil driver and the voice coil of the high frequency speaker are driven out-of-phase from those from the first baffle but in-phase with one another. The coils of the speakers are driven from suitable filter circuits. Various forms of loudspeaker systems have been developed, and the types of speakers as well as the technologies involved pertaining to woofers, tweeters, mid-range and other forms of speaker systems are well known. Stereo sound systems using front speakers with or without some form of woofer or subwoofer, along with rear and/or side speakers, have become prevalent particularly for sound systems used to reproduce sound in “home theater” video systems for playing back video motion pictures and similar program material. The typical installation comprises a pair of front speakers positioned to either side of the TV screen, preferably with a center speaker and/or a subwoofer, and along with a pair of right and left side speaker and/or a pair of left and right rear speakers. An Audio Engineering Society (AES) paper entitled “New Factors in Sound for Cinema and Television” by Tomlinson Holman, presented at the 89th Convention of the Audio Engineering Society, Los Angeles, Calif., Sep. 21-25, 1990, and reprinted in the Journal of the AES, Volume 39, No. 7/8, (preprint #2945) notes that the best directivity pattern for the “surround” loudspeakers is not the conventional forward radiating direct radiator, but rather dipolar radiation with the principal lobes of the dipole pointed, not at the listening area, but at the room surfaces with the null in the radiation pattern pointed at listeners, and that the best surround loudspeaker is physically invisible.

U.S. Pat. No. 5,073,945 teaches a loudspeaker system that has dipole type characteristics and includes a pair of loudspeakers which are mounted on the front baffle board and the back baffle board of a console and are connected to be driven in each other opposite phase relation and have substantially the same acoustic characteristics in the medium and high frequency range but different acoustic characteristic in low frequency range; such loudspeaker system produces good surround-sound effect when used as back loudspeakers only with small number.

U.S. Pat. No. 5,109,416 teaches a dipole speaker that produces ambience sound. The dipole speaker is for use with a multi-channel sound reproduction system for producing an acoustical ambience signal. The dipole speaker includes a transducer which is connected to the sound reproduction system so that it receives a difference signal from between the channels thereof. The transducer may be a unitary loudspeaker or a pair of identical, outward-facing loudspeakers. In response to a difference signal, the transducer generates first and second sound pressure lobes which extend in opposite directions from the dipole speaker. The lobes are 180 degrees out of phase so that they cancel one another out to produce a null zone which extends in a plane about the speaker. The dipole speaker is used in conjunction with conventional direct-path speakers which are connected to the sound reproduction system. The dipole speaker is positioned in a defined listening area so that the null zone is aligned towards the listener to avoid any sound traveling along a direct path from the speaker to the listener, and the sound pressure lobes are directed towards the walls of the listening area so that the acoustic signal of the dipole speaker is reflected there-from and arrives at the listener by way of indirect paths. The acoustic signal of the dipole speaker is thus sensed by the listener as arriving from various directions, and its arrival is delayed relative to the arrival of the acoustic output of the direct-path speakers due to the longer lengths of the indirect paths, both of which enhance the ambience of effect of the acoustic output of the dipole speaker.

Ideally, sound reproduced through a sound reproduction system, such as that of a stereo high fidelity system, a television, or the like, would sound like the original source. In part, this means that the reproduced sound should have a spatial dimension or quality in that a listener should perceive the sound as being distributed in space as it would be if listening to the original performance. Unfortunately, a problem with conventional sound reproduction systems is the tendency of the sound to be localized by the listener at the loudspeakers, or imaged at a point relative to the loudspeakers. When a listener hears an original performance, the listener receives some acoustical signals which permit the listener to localize the source of the sound, for example, a particular singer or instrument, and other signals which provide a sense of a spatial dimension, which will be referred to from time-to-time hereinafter as “ambience”. The first category of signal is comprised of those which travel along a substantially straight path from the source to the listener; the second set of signals, which are not readily localizable, are those which are reflected off of the walls, ceiling, floor, fixtures, and the like of the listening area. It is these latter signals which provide the sense of ambience or spatiality, and this quality is imparted both by their arrival at the listener from a variety of directions, and by the fact that their arrival is delayed relative to those signals which travel directly from the source to the listener; this delay is the result of the longer paths which the reflected signals must travel. The ambience signals may consequently be delayed on the order of 10 or more milliseconds as compared to the direct path signals. A number of approaches have been proposed for reproducing the ambience signals with a sound reproduction system. Some of these have employed electronic delay circuitry to delay the signal from the left and right channels of the amplifier of a conventional stereo system, the delayed output then being supplied to dedicated right and left speakers which project the delayed signal along direct paths to the listener. While this approach has achieved some success in producing a “surround sound” effect, it possesses a number of inherent disadvantages: not only is the delay circuitry (which typically requires housing in a separate component) both relatively expensive and noisy, but the approach also ordinarily employs two dedicated “surround sound” speakers, in addition to the conventional, non-delayed speakers of the stereo system.

U.S. Pat. No. 4,596,034 teaches a system in which each channel of a stereo system is reproduced in full by first and second transducers with the output of the first transducer being 180 degrees out of phase with respect to the output of the second transducer. The transducers are positioned such that their acoustic outputs, that is, their sound pressure lobes, are directed to either side of the listener, and a pressure minimum, or null zone, formed between the two lobes is directed towards the listener, eliminating all direct path sound so as to provide a sound field which prevents the listener from localizing the speakers. While this arrangement may help produce an enhanced sense of sound distribution and a decreased awareness that the sound is coming from speakers, this system also possesses several inherent disadvantages. The most significant of these lies in the very fact the system is intended to prevent the listener from localizing sound for the whole of both channels of the stereo system; in other words, this arrangement renders it difficult or impossible for the listener to localize any of the acoustical signals which are reproduced by the system, regardless of whether those signals were originally recorded as direct path signals or indirect path signals. This is undesirable in that it consequently makes it impossible for the listener to localize those sources (e.g., a singer or particular instrument) where a degree of localization is desirable. The practical result is that the reproduced sound is perceived as being formless or “mushy”.

U.S. Pat. No. 5,199,075 and U.S. Pat. No. 5,301,327 teach a sound loudspeakers and processor system for the multi-channel reproduction of sound in which a plurality of loudspeakers connectable to a surround sound processor is disclosed. Circuits for adapting the processor provide left and right side output signals. Dual, left side and right side, loudspeakers each of which contains two independent drivers. One loudspeaker faces the front and the other facing the rear of the listening area. The front-facing drivers is connectable to the left and right side output signals and the rear-facing drivers being connectable to the corresponding left and right rear output signals of the processor. The dual loudspeakers operate in a first mode to produce a dipole sound radiation pattern whenever the signals are applied in anti-phase to the front-facing and rear-facing drivers thereof, thereby producing a diffuse sound field, and operate in a second mode to produce a hemispherical, omni-directional sound pattern when the signals are applied to the respective drivers in phase, thereby producing a focused sound field with good localization characteristics. An operation mode-switching circuit implements the desired mode selectable by the user. Surround sound processing, in general, is a technique wherein a stereophonic pair of signals from a source such as prerecorded audio or live transmissions of audio signals, with or without video, is processed to yield a set of signals for the purpose of feeding several loudspeakers placed around the listening area, so as to give an impression of spatially surrounding the listener with the sounds, articularly any ambience, and/or broadening the sound field to wrap around the listener.

U.S. Pat. No. 5,809,150 teaches a surround sound loudspeaker system. The generation of skewed hyper-cardioid sound energy fields (in polar diagrams) from right front and left front “surround” loudspeakers with the principal nulls directed at the expected listener location produces the effect of sidewall and rear-wall loudspeakers in a home theater setting without any actual sidewall or rear-wall loudspeakers. The effect is enhanced by secondary nulls that are directed so as to “reflect” off the front wall of the room toward the expected listener location. Each surround loudspeaker contains an anti-phase driver and circuitry including a delay network that powers the drivers to create the skewed hyper-cardioid sound energy field. The invention is independent of electrical mixing and interaction of two or more input channels. Rather the channels are assumed to be independent and the invention concerns the unique directional sound energy radiation pattern generated from each channel considered independently. An important feature of the skewed hyper-cardioid sound energy field according to the invention is the insensitivity of the principal null direction to frequency over a range of 120 Hertz to 4 kilohertz. Also important is a surround sound effect more pronounced in miniature (close range) speaker configurations because the energy gradient between the right and left ears is steeper with the skewed hyper-cardioid at close range. This is a generalized method of handling direct and reflected sound in an enclosed listening space, since the parameters are variable with delay in the circuitry, the angular relationship of the drivers in the loudspeaker cabinet and the shape of the cabinet. In some listening configurations only the surround loudspeakers are necessary for superior sound reproduction. The audio loudspeakers are used in plural to realistically recreate the direct and ambient sound of an audio only, or an audio visual work such as a movie or television program and, in particular, in a home theater setting to provide sound from all directions to the viewer-listener. The audio loudspeakers are also used for reproducing in a more realistic manner audio recordings in general (“auralization”). Stereophonic sound systems utilizing two loudspeakers are common. More recently bass units (subwoofers) have been added as a third separate loudspeaker. The main purpose of adding this third speaker is to allow smaller left and right speakers, thus increasing the overall convenience of the sound installation. In home theater settings the two loudspeakers have been to either side of a movie or television screen with the bass unit placed in any convenient location. Since the bass unit location has not been generally considered critical, the bass unit has frequently been hidden behind or under any convenient piece of furniture. Such stereophonic systems have been very successful. Also, in the past, loudspeakers have been disclosed wherein a polar plot of the sound energy comprises a cardioid, the null in energy being on the axis of symmetry through the major lobe. Such a polar plot arises from loudspeakers as disclosed in Olson, Harry F., “Gradient Loudspeakers”, Journal of the Audio Engineering Society, Vol. 21, No. 2, March 1973, pp. 86-93. Taking the polar plot a step further to a hyper-cardioid (which can be accomplished by varying the driving signal delay between the physically spaced speaker elements), the plot comprises a major lobe and a minor lobe. Both lobes are symmetric about the same axis with symmetric nulls to each side of the axis. Where the major lobe and minor lobe are the same size (dipole) the nulls face directly opposite each other and are symmetric about a cross axis in turn perpendicular to the axis of symmetry of the lobes as shown by Olson (see also U.S. Pat. No. 4,961,226). Unequal lobes cause the nulls to face in equiangular directions relative to the axis of symmetry. Such polar plots arise from loudspeakers also disclosed by Olson. “Dipole” loudspeakers are described by Olson as gradient loudspeakers with zero electrical delay between the driver elements. “Dipole” loudspeakers have been placed next to side walls with difference signals produced by electronic processing of the stereo signals supplied to the sidewall speakers. Such an arrangement can provide double dipole sidewall loudspeakers with nulls facing the audience and the walls in an auditorium setting.

U.S. Pat. No. 4,819,269 teaches sidewall loudspeakers that broadcast over a 180 arc degrees. The former of these disclosures teaches use of a five or seven channel surround sound processor whereas the latter teaches a two (stereo) channel sound source with additive or subtractive electric combinations of the two channels fed to the sidewall and rear-wall loudspeakers. U.S. Pat. No. 4,819,269 further teaches an additive or subtractive approach to two channels fed to two loudspeakers in an article, Klayman, Arnold I., “Surround Sound With Only Two Speakers”, Audio, August 1992, pp. 32-37.

Of interest is the research disclosed in Kantor, K. L. and DeKoster, A. P., “A Psycho-acoustically Optimized Loudspeaker”, Journal of the Audio Engineering Society, Vol. 34, No. 12, December 1986, pp. 990-996; wherein the optimal angles of the direct sound and the ambient sound maxima to the listener are 26 degrees and 54 degrees with 0 degree being defined as directly forward of the listener. Such an arrangement is said to cause minimum inter-aural cross-correlation.

Also of interest are recent articles on binaural recording and loudspeaker reproduction as well as transaural recording and reproduction in Griesinger, David, “Theory and Design of a Digital Audio Signal Processor for Home Use”, Journal of the Audio Engineering Society, Vol. 37, No. 1/2, January/February 1989, pp. 40-50; Griesinger, David, “Equalization and Spacial Equalization of Dummy-Head Recordings for Loudspeaker Reproduction”, Journal of the Audio Engineering Society, Vol. 37, No. 1/2, January/February 1989, pp. 20-29; and Cooper, Duane H., and Bauck, Jerold L., “Prospects for Transaural Recording”, Journal of the Audio Engineering Society, Vol. 37, No. 1/2, January/February 1989, pp. 3-19. The new loudspeaker surround sound technique disclosed below can be used to increase the robustness of the trans-aural techniques and significantly reduce the amount of signal processing required to achieve the desired acoustic effects.

United States Patent Application No. 20030118194 teaches a multi-mode ambient soundstage system that includes a direct radiation sound device, a diffuse radiation sound device and a selection device in signal communication with both the direct radiation sound device and diffuse radiation sound device, the selection device capable of selecting between the direct radiation sound device for one mode of operation and the diffusion radiation sound device for another mode of operation in response to a received control signal.

Sound reproduction devices such as loudspeakers are utilized in a broad range of applications in many distinct fields of technology including the consumer and industrial fields. Sound reproduction devices utilize a combination of mechanical and electrical components to convert received electrical signals, representative of the sound, into mechanical energy that produces sound pressure waves in an ambient sound field corresponding to the received electrical signals. In today's society, the utilization of home theater systems is increasing as consumers attempt to reproduce the cinema and concert theater experiences within their homes. As a result, manufactures have produced numerous types of audio and video systems capable of reproducing different types of theater environments within the home of a consumer. These theater environments include analog and digital surround sound, Dolby Digital Sound, digital theater System (“DTS”), extended DTS (“DTS-ES”), THX and other digital signal processing (“DSP”) modes. The audio and video systems capable of producing these theater environments include numerous electronic components and loudspeakers. Typically the systems include from six to eight loudspeakers to produce various ambient sound fields. As an example of a cinema theater environment, a 5.1 type cinema theater system includes a pair of left and right front loudspeakers, a center channel loudspeaker, a pair of left surround loudspeakers and a subwoofer loudspeaker. A 6.1 type cinema theater system includes a pair of left and right front loudspeakers, a center channel loudspeaker, a pair of left surround loudspeakers, a back surround sound loudspeaker and a subwoofer loudspeaker. A problem with these audio and video systems is that the surround sound loudspeakers in these systems are either dipolar or bipolar and are placed external to the wall surfaces of a room containing the system. As a result, mass consumer acceptance of some of these types of systems is relatively low because the surround loudspeaker are bulky, visually unappealing and tend to force a consumer to utilize the room exclusively for a cinema home theater system. Attempts have been made at utilizing in-wall and in-ceiling loudspeakers. However, it is difficult to produce an ambient sound field equivalent to the external surround sound loudspeakers with a sound reproduction system that is imbedded and flush within the wall and ceiling surfaces because the dispersion from its locations within walls are obscured by the wall and ceiling surfaces. Typically, unless the loudspeaker is capable of producing an angled pattern for the sound, the loudspeaker will be obstructed and will not be able to create the type of sound stage that is desirable for accurate sound reproduction within the home theater system. Therefore, there is a need for a sound reproduction system that is capable of producing an ambient sound field equivalent to external surround sound loudspeakers while being imbedded in the wall and/or ceiling and being flush with the wall and ceiling surfaces of a room. An additional problem with these audio and video systems is that typically rooms are arranged differently from home-to-home. Some rooms are small and have four walls while others may be large and only have three, or two, main walls that are compatible for placing loudspeakers. Thus, there is also a need for a sound reproduction system that is capable of producing an ambient sound field equivalent to external surround sound loudspeakers while being imbedded in various locations on the walls and ceilings of a room, while at the same time being flush with the wall and ceiling surfaces of the room. Still another problem is that generally audio and video systems that are optimized for a cinema environment are different than audio systems that are optimized for a music listening environment. Typically, cinema environments require dipolar or bipolar surround sound loudspeaker configurations to produce diffuse ambient sound fields, while music listening environments require direct radiating type loudspeakers to accurately reproduce the music. Thus there is also a need for a sound reproduction system that is capable of producing an ambient sound field for both cinema and music environments equivalent to external surround sound loudspeakers while being imbedded in the wall and/or ceiling and being flush with the wall and ceiling surfaces of a room.

U.S. Pat. No. 3,013,905 teaches a transducer which includes a magnet plate and a membrane. The magnetic plate is made from highly coercive oriented ferrite material, e.g. the barium ferrite commercially known as “Indox V” of a high coercive force.

U.S. Pat. No. 4,484,037 teaches a ribbon-type electro-acoustic transducer which has a magnetic system. The magnetic system includes an upper plate and a center pole between which an air gap is formed. A diaphragm on which conductors are arranged is disposed in the air gap. The upper plate includes two plate-shaped parts between which a space is formed in which an edge portion of the diaphragm is located.

U.S. Pat. No. 5,850,461 teaches a diaphragm mounting system for flat acoustic planar magnetic and electrostatic transducers. The system incorporates opposing frame sections. Each frame section defines a clamping or peripheral surface area and an internal or central area through which acoustic waves may pass from the diaphragm.

U.S. Pat. No. 4,471,172 teaches a planar diaphragm type magnetic transducer with magnetic circuit in which the magnet strips on the soft iron plate and confronting the diaphragm are arranged in a sequence south, north, north, south, south, north, north, south, et seq. The magnet strips are spaced across the transducer and the metal plates on which the magnet strips lie are apertured to make the plates acoustically transparent. Conductors are grouped in runs on the diaphragm opposite alternate pairs of magnet strips. The magnet strips have magnetic poles of opposite polarity at their front faces.

U.S. Pat. No. 6,104,825 teaches a planar magnetic transducer that includes a clamping frame, a diaphragm with an electrical conductor and a plurality of magnetic bars. The diaphragm is secured to the frame and has an active surface area under tension spaced inwardly of the frame. The electrical conductor is disposed on the active surface area of the diaphragm. The magnetic bars are mounted so that they are spaced from said diaphragm.

The inventor hereby incorporates the above referenced patents into this specification.

### SUMMARY OF THE INVENTION

The present invention relates to a loudspeaker that primarily is used for home theater or multi-channel sound systems. The loudspeaker includes an enclosure, a wide band transducer mounted in such a way that it can be rotated around its vertical axis and an aiming knob that is mechanically connected to the transducer and controls the transducer's rotation angle. The transducer has both font and rear sides open and thus operates as a dipole. The loudspeaker may contain an additional low frequency transducer and a crossover network in the same enclosure to augment dipole transducer and extend the loudspeaker's operating range into lower frequencies. The enclosure is arranged so that a part of it, housing the dipole transducer, has at least one top or bottom panel that carries the dipole transducer and the aiming knob. This part of the enclosure has at least three open sides: frontal, left and right, allowing the dipole transducer unobstructed sound radiation into a room at any angle of its rotation within at least 180 degrees. The rear side that faces the wall may be solid to allow wall mounting and better structural integrity of the cabinet. The rear panel may also be covered with sound absorptive material. The best results can be obtained with relatively thin dipole transducer such as planar magnetic or electrostatic type.

In the first aspect of the invention the aiming knob provides the rotation of the dipole transducer and helps a user to determine the direction of the main radiation pattern lobe without actually seeing the transducer's or the knob's position. The aiming knob has elongated and pointed shape so that it points in the direction of direct sound radiation in the plane of rotation.

In the second aspect of the invention the loudspeaker provides to a listener the ability of choosing and aiming a particular horizontal polar pattern axis of the dipole transducer to a desired listening position in the room depending on sound program material or personal preferences. A user can aim the dipole transducer with either a main radiation pattern lobe with predominantly direct sound field or with polar pattern null having minimal direct sound energy but generating a predominantly diffuse sound at the listening position.

In the third aspect of the invention the ability to rotate and aim the dipole transducer in horizontal plane provides flexibility in the loudspeaker installation. If the loudspeaker is used for a surround sound applications, it can be installed almost anywhere in the rear part of the room behind the listener where the speakers can deliver acceptable performance. The location is not limited by loudspeaker's sound dispersion characteristics and provides more freedom for user preferences in room design and convenience.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a perspective view of a loudspeaker according to the present invention that has a dipole transducer and an aiming knob wherein the consequently main radiation lobe is aimed perpendicularly to the rear panel.

FIG. 2 is a perspective view of the loudspeaker of FIG. 1 the present invention wherein the consequently main radiation lobe is aimed parallel to the rear panel so that the null radiation axis is therefore aimed at 90 degrees perpendicularly to the rear panel.

FIG. 3 is a schematic diagram of a rear part of a home theater system set up according the present invention wherein the dipole transducer is aimed at the listener with its main radiation pattern lobe.

FIG. 4 is a schematic diagram of a rear part of a home theater system set up according the present invention wherein the dipole transducer is aimed at the listener with its radiation pattern null axis.

FIG. 5 is a diagram of a home theater system set up according the present invention. The black area indicates possible location of the surround sound loudspeakers in case of two rear channels.

### DESCRIPTION OF THE PREFERRED EMBODIMEN

The current situation with rear channel loudspeakers in home theater and multi-channel audio has a confusing element for a user. Surround sound audio in its recent reincarnation was first boosted by consumer version of Dolby Surround systems for movies and special THX processing algorithm developed for consumer home theater systems. The idea is to transfer the movie theater audio experience into a home environment. According to THX recommendations the home theater system should have at least 5 audio channels, frontal left, frontal center, frontal right and two surround sound channels located to the rear of the listening position. While frontal channels specify mostly direct radiating loudspeakers, the rear channels according THX should produce predominantly diffuse sound. Dipole speakers aimed at the listener with their “nulls” are preferred in order to recreate the ambient sound field and envelopment as intended by movie mix producers. With advent of multi-channel music-only formats such as SACD and DVD-A, rear channel loudspeakers have been specified as preferably having the same radiation characteristics as frontal loudspeakers. Therefore most of the multi-channel music programs are mixed using direct radiating rear channel loudspeakers. Naturally, its playback should be performed using direct radiating rear loudspeakers. As the result, the rear channel loudspeakers for home theater have different recommended dispersion characteristics than for multi-channel music reproduction. This creates a problem for manufacturers and even more the end users. Most of surround sound speakers on the market are either direct radiators or feature a complex and compromised combination of direct radiating woofer and spatially disconnected tweeters with bi-pole/dipole switch. Neither of these configurations can generate a truly diffuse field over a wide vocal region band with minimum energy radiation towards a listener. The latter design is totally compromised because it can not provide either direct sound that is equal to the sound of frontal speakers or truly diffuse sound possible only from a true dipole when it is directed to a listener with its radiation null.

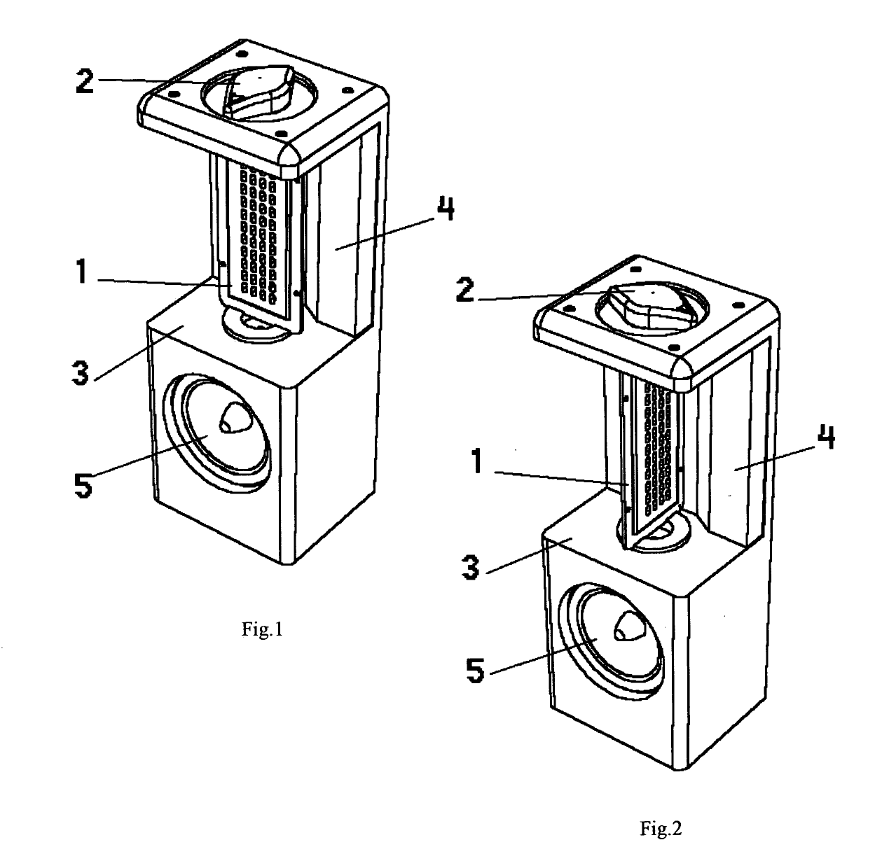

Referring to FIG. 1 a loudspeaker includes a dipole transducer 1, an aiming knob 2 mechanically connected with the said transducer, an enclosure 3, a sound absorbing pad 4 and a low frequency transducer 5. The loudspeaker may contain crossover network, input terminals and wall mounting means. The dipole transducer 1 is mounted in such a way that it can be rotated around its vertical axis with the help of the aiming knob 2 that is mechanically connected to the transducer 1 and controls the transducer's angle of rotation. The dipole transducer 1 has both font and rear sides open and thus operates as a dipole radiator. The best results can be obtained with relatively thin dipole transducer such as planar magnetic or electrostatic type. The dipole transducer 1 preferably operates in a wide frequency range covering the whole vocal spectrum and above. A dipole radiator is known to be very inefficient at low frequencies. Therefore the loudspeaker may contain additional low frequency transducer 5 in the same enclosure to augment the dipole transducer 1 and extend the loudspeaker's operating range into lower frequencies. The enclosure 3 is arranged so that a part of it, housing the dipole transducer, has at least one top or bottom panel that carries the dipole transducer 1 and the aiming knob 2. This part of the enclosure 3 has at least three open sides: frontal, left and right, allowing the dipole transducer 1 unobstructed sound radiation into a room at any angle of its rotation within at least 180 degrees. The rear side that faces the wall is solid to allow wall mounting and better structural integrity of the cabinet. The rear panel is covered with sound absorbing pad 4. This pad helps to absorb sound energy when the dipole transducer 1 is positioned parallel to the rear panel and half of its radiated sound is directed backwards. The aiming knob has preferably elongated shape with unmistakable for a user visual and tactile pointing features such as textured and colored arrow signs, relatively sharp pointing ends etc. These pointing features are aligned with the dipole transducer 1 and point in the same direction as the main radiation pattern lobe. The aiming knob 2 provides easy identification and aiming of the main lobe in the desired direction without use of any complicated electronic or mechanical devices. The control is easy and intuitive. A user may not even look at the aiming knob or see the dipole transducer which is normally hidden under grille fabric, knowing that the knob points in the direction of sound radiation. It is known that a dipole transducer has “FIG. 8” directivity polar pattern. The dipole planar transducer 1 on FIG. 1 is aimed with its main radiation lobe perpendicularly to the speaker's rear panel (mounting plane).

Referring to FIG. 2 in conjunction with FIG. 1 the dipole planar transducer 1 is aimed with its main radiation lobe parallel to the rear panel (mounting plane) of the speaker and its radiation null axis being perpendicular to this plane.

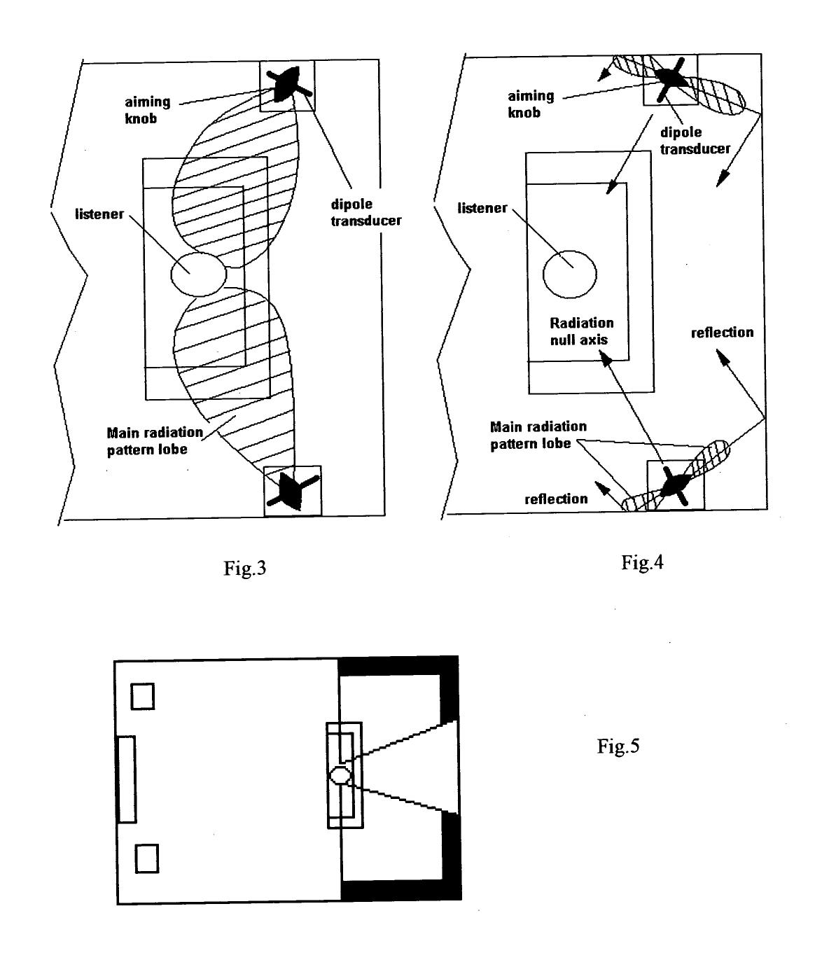

Referring to the FIG. 3 in conjunction with FIG. 1 by aiming the knob towards the listening position a user will direct sound energy at this position. There will be much less, reflected or diffuse sound energy reaching this spot. This set up is preferable for multi-channel music reproduction.

Referring to the FIG. 4 in conjunction with FIG. 1 aiming the knob at 90 degrees to the line connecting the speaker and the listening position directs sound energy away from the listener. In this case the listener will receive very little direct sound but mostly diffuse sound created by multiple reflections. This set up is preferable for home theater movie reproduction. Another key benefit of the aiming knob is the user is provided with the ability to choose between predominantly direct radiating system or the system generating predominantly diffuse sound. All this is done with a simple turn of the aiming knob. The planar dipole transducer allows for very effective and dramatic difference in direct/diffuse sound field that none of the other compromised designs currently on the market can provide. A listener can be positioned extremely close to the surround sound speaker (less than 2 feet) and be unable to identify this speaker by the direction of its radiated sound if the speaker's null is aimed at the listener. This feature allows successful use of a home theater system in many small contemporary rooms that are not dedicated for home theater and where there is little space. In such cases a listener is often positioned very close to the rear speakers and rather far from the frontal speakers. This results in overpowering by surround sound speakers due to Haas effect (precedence effect) and less than optimal performance on the whole.

Referring to the FIG. 5 there is a knob to rotate and aim the dipole transducer in horizontal plane provides flexibility in the loudspeaker installation. If the loudspeaker is used for a surround sound applications, it can be installed almost anywhere in the rear part of the room behind the listener (area shaded in black) where the speakers can deliver acceptable performance. The location is not limited by loudspeaker's sound dispersion characteristics and provides more freedom for user preferences in room design and convenience. The possible location spots can range from directly at the side of the listener to almost 150 degrees away from the listening axis.

The aiming knob can be can be controlled by electromechanical device for speaker orientation. A servo motor may be coupled to the transducer. Optionally the servo motor may be operated by a remote control device with aiming information displayed on a monitor screen.

The system has three sides open (left, front and right) which automatically somewhat limits the use to on-wall or freestanding position, the speaker in general can be accommodated for in-wall mounting as well with certain degree of compromise. In this case it can be recessed in the wall and have slightly angled surfaces on each side to direct sound energy out of the cavity accordingly.

In this case the aiming knob 2 can be positioned on the front of the speaker and can be implemented in the form of the rotating wheel which other visual and tactile means for aiming identification.

The speaker combines both radiation patterns without complex electronic circuitry and without major acoustical compromises and provides simple means to control the radiation pattern.

A driver has magnets that positioned from at least one side. The driver has certain features like progressive driving force and progressive acoustic dampening. An asymmetrical design is also valid and actually can deliver better results in certain cases. A driver may have N magnets at the back and N−2 magnets are at the front both with progressive dampening. The drivers may have only one side according the claims while the other side could have regular configuration with larger number of magnets. Both sides may have with the rear having two more magnets on the sides. A planar driver may also have a different number of magnets from the front and from the back. Any progressive driving force that should be concentrated preferably in the middle and progressive dampening that should be concentrated preferably at the periphery. Although an asymmetrical magnet configuration may be used that this should be specifically located in the middle and add our idea about progressive dampening on the sides.

From the foregoing it can be seen that a loudspeaker for use in home theater or multi-channel sound systems that includes an enclosure, a dipole transducer and an aiming knob. In the description, specific materials and configurations have been set forth in order to provide a more complete understanding of the present invention.

Accordingly it is intended that the foregoing disclosure be considered only as an illustration of the principle of the present invention.

What is claimed is:

1. A loudspeaker for use in home theater or multi-channel sound systems comprising:
a. an enclosure;
b. a wideband transducer rotatably mounted in said enclosure so that said wideband transducer can be rotated around its vertical axis; and
c. an aiming knob mechanically coupled to said wide band whereby said aiming knob controls the rotation angle of said wideband transducer.

2. A loudspeaker according to claim 1 wherein said wideband transducer has a front side and a rear side open so that said wideband transducer operates as a dipole transducer.

3. A loudspeaker according to claim 2 wherein said loudspeaker includes a low frequency transducer and a crossover network in said enclosure in order to augment said dipole transducer thereby extending said the operating range of said loudspeaker into lower frequencies.

4. A loudspeaker according to claim 3 wherein said enclosure is arranged so that a part of it that houses said dipole transducer has at least one top or bottom panel that carries said dipole transducer and said aiming knob and has at least three open sides, front, left and right thereby allowing said dipole transducer to provide unobstructed sound radiation into a room at any angle of its rotation within at least 180 degrees and wherein a rear side of said enclosure, that faces the wall, is a panel that is solid and allows both wall mounting and better structural integrity of said enclosure.

5. A loudspeaker according to claim 4 wherein said panel of said rear side is covered with a sound absorptive material.

6. A loudspeaker according to claim 3 wherein said wideband transducer is a relatively thin dipole transducer.

7. A loudspeaker according to claim 6 wherein said dipole transducer is a planar magnetic type.

8. A loudspeaker according to claim 6 wherein said dipole transducer is an electrostatic type.

9. A loudspeaker according to claim 2 wherein said aiming knob provides the rotation of said dipole transducer and helps a user to determine the direction of the main radiation pattern lobe without actually seeing the position of either said dipole transducer or said aiming knob whereby said aiming knob has an elongated and pointed shape so that said aiming knob points in the direction of direct sound radiation in the plane of rotation.

10. A loudspeaker according to claim 3 wherein said loudspeaker provides to a listener an ability of choosing and aiming a particular horizontal polar pattern axis of said dipole transducer to a desired listening position in a room depending on sound program material or personal preferences so that a user can aim the dipole transducer with either a main radiation pattern lobe with either a predominantly direct sound field or a polar pattern null having minimal direct sound energy but generating a predominantly diffuse sound at the listening position.

11. A loudspeaker according to claim 3 wherein said loudspeaker has an ability to rotate and aim said dipole transducer in a horizontal plane and provides flexibility in a loudspeaker installation so that if said loudspeaker is used for a surround sound application said loudspeaker can be installed almost anywhere in the rear part of a room behind the listener whereby said loudspeaker can deliver acceptable performance whereby its location of said loudspeaker is not limited by its sound dispersion characteristics thereby providing more freedom for user preferences in room design and convenience.

12. A loudspeaker for use in home theater or multi-channel sound systems comprising:
a. an enclosure;
b. a wideband transducer rotatably mounted in said enclosure so that said wideband transducer can be rotated around its vertical axis; and
c. an aiming knob mechanically coupled to said wide band whereby said aiming knob controls the rotation angle of said wideband transducer whereby said loudspeaker uses said dipole transducer to create a diffuse field.

13. A loudspeaker according to claim 12 wherein said wideband transducer has a front side and a rear side open so that said wideband transducer operates as a dipole transducer loudspeaker.

14. A loudspeaker according to claim 13 wherein said loudspeaker also includes a sound absorbing pad.

15. A loudspeaker for use in home theater or multi-channel sound systems comprising:
a. an enclosure;
b. a wideband transducer rotatably mounted in said enclosure so that said wideband transducer can be rotated around its vertical axis; and
c. an aiming knob mechanically coupled to said wide band whereby said aiming knob controls the rotation angle of said wideband transducer whereby loudspeaker uses said dipole transducer to create direct radiating surround sound.

16. A loudspeaker according to claim 15 wherein said wideband transducer has a front side and a rear side open so that said wideband transducer operates as a dipole transducer loudspeaker.

17. A loudspeaker according to claim 16 wherein said loudspeaker also includes a sound absorbing pad.
